(19) United States
(12) Patent Application Publication
(10) Pub. No.: US 2015/0195778 A1
(43) Pub. Date: Jul. 9, 2015

(54) WIRELESS COMMUNICATION SYSTEM PROVIDING OPTIMAL NETWORK PERFORMANCE

(71) Applicant: Sirran Technologies Limited, Dublin (IE)

(72) Inventor: Dean Parsons, Dublin (IE)

(21) Appl. No.: 14/419,057

(22) PCT Filed: Jul. 24, 2013
(86) PCT No.: PCT/EP2013/065629

§ 371 Date: Feb. 2, 2015

(30) Foreign Application Priority Data
Jul. 31, 2012 (GB) 1213608.1

(51) Int. Cl. H04W 48/18; H04W 8/02; H04W 76/02

(52) U.S. Cl. CPC H04W 48/18; H04W 76/02; H04W 8/02; H04W 88/06

(57) ABSTRACT

A wireless communications device comprising a control means, and being connectable to a plurality of networks. The control means is operable to effect the sending of a piece of information from the wireless communications device via a plurality of networks to a target device. The piece of information is used to derive one or more operational characteristics of each of the plurality of networks. The control means is configured to compare the one or more operational characteristics and to select a preferred network. The control means is configured to effect connection of the wireless communications device to the preferred network.

### FIELD OF INVENTION

The present invention relates to a wireless telecommunication system in which a communication device communicates with a telecommunications network.

### BACKGROUND OF THE INVENTION

Wireless telecommunication systems are configured such that they are compliant with a particular standard, which specifies various functional details in relation to how the associated equipment is required to operate.

One such standard is the Global System for Mobile Communications (GSM) standard. GSM broadly describes technologies for second generation (2G) digital cellular networks, and replaced earlier first generation analogue networks. GSM has been developed to include first circuit switched data transport, and General Packet Radio Services (GPRS) which enables packet data transport. Further standards which offer yet further improved functionality are the third generation (3G) and fourth generation Long Term Evolution (4G LTE) Advanced standards.

Accordingly, mobile devices, such as telephones, can be configured to operate in accordance with one or more of the above standards. Secure communication using these standards can be provided through the use of Voice over Internet Protocol (VoIP) over a typical mobile data session, together with means for encrypting the data session.

VoIP operations have session control protocols to control the set-up of calls together with audio codecs that encode speech and thereby enable the transmission of speech as digital audio by means of an audio stream over an IP network. Various providers include Skype via the 2G standard, and Google Talk via the 3G standard. The data session may be encrypted by means of a server that provides for protocol conversion using: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR).

Generally, within a particular region or country, there may be a large number of networks which a mobile device is operable to connect to. It is well-known that the comparative performance of networks can vary. Since VoIP generally requires a relatively high data bandwidth and low data packet latency, when using VoIP in the above manner it is particularly desirable that the mobile device is connected to the network which provides optimum bandwidth/latency.

However, according to conventional telecommunication systems, when a mobile device is powered up, or the location thereof has changed such that a network provider selection requires a review, the mobile device is generally configured to select a network based on a service agreement, such as roaming agreement, between network providers or Mobile Virtual Network Operators (MvNO). For instance, the mobile device is provided with a list of potential networks, and the mobile device is configured to automatically connect to the first available network on the list. This can lead to selection of a network which is not the optimum, and potentially which does not offer the required data bandwidth and/or data packet latency.

An object of the present invention is therefore to overcome one of the above or other problems.

### SUMMARY OF THE INVENTION

According to a first aspect of the invention there is provided a wireless communications device, the wireless communications device comprising a control means, and being connectable to a plurality of networks, wherein:

the control means is operable to effect the sending of a piece of information from the wireless communications device via a plurality of networks to a target device,

characterised in that the piece of information is used to derive one or more operational characteristics of each of the plurality of networks,

wherein the control means is configured to compare the one or more operational characteristics and to select a preferred network,

the control means being configured to effect connection of the wireless communications device to the preferred network.

Preferably, the piece of information is returned from the target device to the wireless communications device.

Preferably, the piece of information comprises information gathered from a Packet Internet Groper (PING).

Preferably, the wireless communications device comprises a first list defining the plurality of networks, in a particular region or locality that the wireless communications device can establish a connection with.

Preferably, the control means is configured to achieve a connection between the wireless communications device and the first network on the first list, and thereafter to send the piece of information to the target device via the first network on the list and preferably receive a response back from the target device. Preferably, thereafter, the control means is also configured to sequentially establish a connection with each of the subsequent networks on the list and to send the piece of information via these networks to the target device, and receive a response back from the target device for each network.

Preferably, the control means is configured such that once the piece of information has been sent to and preferably responded to by the target device via each of the networks on the list, the operational characteristics of the networks on the list are compared.

Preferably, the operational characteristics are one or more of the following: the mobile communication standard, data bandwidth and data latency.

Preferably, the control means is configured such that the preferred network is selected by firstly selecting networks with the highest bandwidth, for instance, by means of selecting all networks with the standard having the highest bandwidth, thereby defining a second list, and thereafter selecting the network from the second list, wherein the selected network has the lowest data latency.

Preferably, the control means is configured such that after the piece of information has been sent to the target device and returned, the connection to the connected network is terminated so that a connection to a subsequent network can be established.

Preferably, the control means is configured such that the process of deriving the operational characteristics of the networks is initiated in one or more of the following situations: on power up of the mobile device; if the wireless communications device identifies a different Mobile Country Code (MMC); or following a command from a user of the wireless communications device.

Preferably, the first list is stored on a memory of a Subscriber Identification Module (SIM).

Preferably, data relating to the piece of information sent to each network on the first list is stored on the memory of the SIM. Preferably, the data relating to the piece of information sent to each network comprises data for performing a PING. Preferably, the data for performing a PING comprises an IP address of the target device. Preferably, the target device is a server for providing a wireless communication service among wireless communications devices.

Preferably, the wireless communications device is configured to send information via the network using Voice over Internet Protocol (VoIP) over a typical mobile data session.

Preferably, the information can be encrypted by means of a server associated with a network of the target device, the server configured to provide for protocol conversion using: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR).

Preferably, the wireless communications device is a mobile device, such as a mobile handset or a tablet PC.

Preferably, the wireless communications device comprises a SIM. Optionally, the control means is a part of the SIM.

Preferably, the wireless communications device operates in accordance with one or more of the following standards: GSM, 2G, 2.5G (GPRS), 2.75G (EDGE), 3G, and 4G.

According to a second aspect of the invention there is provided a computer program product for a wireless communications device which, when run on a suitable computing means, executes the following steps to effect the sending of a piece of information from the wireless communications device via a plurality of networks to a target device,

characterised in that the information is used to derive one or more operational characteristics of each of the plurality of networks,

wherein the computer program product is configured to compare the one or more operational characteristics to thereby select a preferred network,

the computer program product being configured to effect the connection of the wireless communications device to the preferred network.

According to a third aspect of the present invention there is provided a memory device comprising the computer program product according to the second aspect of the present invention.

According to a fourth aspect of the present invention there is provided a method of connecting a wireless communications device to a preferred network, the method comprising:

sending a piece of information from the wireless communications device via a plurality of networks to a target device;

deriving one or more operational characteristics of each of the plurality of networks; comparing the one or more operational characteristics to thereby select a preferred network; and

connecting the wireless communications device to the preferred network. All of the features described herein may be combined with any of the above aspects, in any combination.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a schematic of a communication system according to an exemplary embodiment of the present invention.

### DETAILED DESCRIPTION OF THE EXEMPLARY EMBODIMENTS

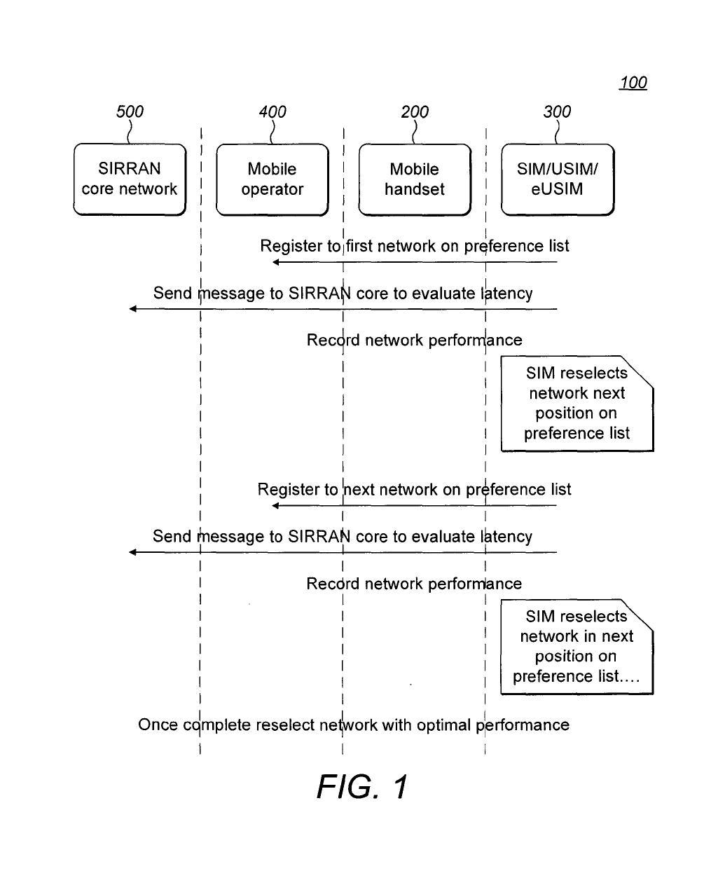

FIG. 1 shows a schematic view of a communication system 100, which comprises a mobile communication device 200 having a Subscriber Identification Module (SIM) 300. The mobile device 200 is operable to connect to a mobile operator network 400.

The system 100 further includes a target network 500, comprising a target device 510, such as a server or any suitable device which comprises a network address. The target network 500 and mobile operator network 400 are arranged such that a data session 410 can be activated on the mobile operator network 400 to thereby obtain a connection between the device 200 and target device 510.

The SIM 300 includes a computer program 310 which is operable to send a Packet Internet Groper (PING) to the target device 510. The computer program 310 contains the network address of the target device 510, which comprises an Internet Protocol address (IP), Media Access Control address (MAC) or other suitable identification means which permits identification of the target device 510 on the target network 500.

Accordingly, the computer program 310 of the SIM 300 is operable to send a PING to the target device 510 via the mobile operator network 400, such that the PING, when returned from the target device 510 to the SIM 300, can be analysed to derive the operational performance of the operator network 400. In particular this is achieved by calculating the data bandwidth, and data latency provided by the operator network 400.

The computer program 310 of the SIM 300 is configured such that the operations described below are initiated in one or more of the following instances; when the mobile device 200 is powered up; when the mobile device 200 identifies a new Mobile Country Code (MCC), for instance, when the mobile device 200 is moved to a different location in a new country or region; user controlled, for instance, via a command sent from an input means on the mobile device 200 to the computer program 310 of the SIM 300.

The SIM 300 is configured such that a plurality of mobile operator networks 400 (or Mobile Virtual Network Operators) are accessible by the mobile device 200 at a given location. The SIM 300 is provided with a list 320 of preferred networks 400. According to one embodiment the list 320 may be provided to the SIM by the target network 500 and stored on a memory of the SIM 300. According to another embodiment the SIM or mobile device 200 is supplied with the list 320 on the memory.

The computer program 310 is configured such that a data session is initially established with the first operator network 400 in the list 320 of the SIM 300. Accordingly, a PING is sent to the target device 510 to establish the operational performance of the first operator network 400. The result of the PING is stored on the memory of the SIM 300. Thereafter, the data session with the first operator network is terminated.

The computer program 310 next establishes a data session with the second operator network 400 in the list 320 of the SIM 300. Accordingly, a PING is sent to the target device 510 to establish the operational performance of the second operator network 400. The result of the PING is stored on the memory of the SIM 300. In an alternative embodiment, the result of the PING is stored on a storage medium of the mobile communication device 200. Thereafter, the data session with the second operator network is terminated.

The above process is repeated sequentially for all the operator networks on the list 320 until the operational performance of all of the operator networks 400 has been established, and hence the list 320 is exhausted.

Thereafter, the computer program 310 compares the operational performance of the networks. According to one embodiment the operational performance is firstly compared by network standard (for instance, 2G, 2.5G (GPRS), 2.75G (EDGE), 3G, and 4G) to select the highest data bandwidth connection, to thereby derive a second list 330. For instance, this may comprise selecting all 4G networks, or all 3G networks in the event that no 4G networks are available. The second list 340 is then compared by latency to derive the best performing network 410.

After the best performing network 410 has been identified, the computer program 310 establishes a data session between the mobile communication device 200 and the best performing network 410.

It will be appreciated that the computer program 310 is not restricted to being part of the SIM 300, for instance, according to another embodiment the computer program may be part of the mobile communication device 200. However, it is advantageous to have the computer program 310 as part of the SIM since this ensures interoperability of the computer program with different mobile communication devices.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A wireless communications device, the wireless communications device comprising a control means, and being connectable to a plurality of networks, wherein:
the control means is operable to effect the sending of a piece of information from the wireless communications device via a plurality of networks to a target device,
characterised in that the piece of information is used to derive one or more operational characteristics of each of the plurality of networks,
wherein the control means is configured to compare the one or more operational characteristics and to select a preferred network,
the control means being configured to effect connection of the wireless communications device to the preferred network.

2. The wireless communications device of claim 1, in which the piece of information is returned from the target device to the wireless communications device.

3. The wireless communications device of claim 1, in which the piece of information comprises information gathered from a Packet Internet Groper (PING).

4. The wireless communications device of claim 1, in which the wireless communications device comprises a first list defining the plurality of networks, in a particular region or locality that the wireless communications device can establish a connection with.

5. The wireless communications device of claim 4, in which the control means is configured to achieve a connection between the wireless communications device and the first network on the first list, and thereafter to send the piece of information to the target device via the first network on the list.

6. The wireless communications device of claim 5, in which the wireless communications device is operable to receive a response back from the target device.

7. The wireless communications device of claim 5, in which, subsequent to establishing a connection to the first network on the first list, the control means is also configured to sequentially establish a connection with each of the subsequent networks on the list and to send the piece of information via these networks to the target device.

8. The wireless communications device of claim 7, in which the wireless communications device is operable to receive a response back from the target device for each network.

9. The wireless communication device of claim 5, in which the control means is configured such that once the piece of information has been sent to and optionally responded to by the target device via each of the networks on the list, the operational characteristics of the networks on the list are compared.

10. The wireless communication device of claim 1, in which the operational characteristics are one or more of the following:
the mobile communication standard,
data bandwidth,
data latency.

11. The wireless communication device of claim 10, in which the control means is configured such that the preferred network is selected by firstly selecting networks with the highest bandwidth, for instance, by means of selecting all networks with the standard having the highest bandwidth, thereby defining a second list, and thereafter selecting the network from the second list, wherein the selected network has the lowest data latency.

12. The wireless communication device of claim 2, in which the control means is configured such that after the piece of information has been sent to the target device and returned, the connection to the connected network is terminated so that a connection to a subsequent network can be established.

13. The wireless communication device of claim 1, in which the control means is configured such that the process of deriving the operational characteristics of the networks is initiated in one or more of the following situations:
on power up of the mobile device;
if the wireless communications device identifies a different Mobile Country Code (MMC);
following a command from a user of the wireless communications device.

14. The wireless communications device of claim 5, in which the first list is stored on a memory of a Subscriber Identification Module (SIM).

15. The wireless communications device of claim 14, in which data relating to the piece of information sent to each network on the first list is stored on the memory of the SIM.

16. The wireless communications device of claim 15, in which, the data relating to the piece of information sent to each network comprises data for performing a PING.

17. The wireless communications device of claim 16, in which the data for performing a PING comprises an IP address of the target device.

18. The wireless communications device of claim 17, in which the target device is a server for providing a wireless communication service among wireless communications devices.

19-24. (canceled)

25. A computer program product for a wireless communications device which, when run on a suitable computing means, executes the following steps to effect the sending of a piece of information from the wireless communications device via a plurality of networks to a target device,
characterised in that the information is used to derive one or more operational characteristics of each of the plurality of networks,
wherein the computer program product is configured to compare the one or more operational characteristics to thereby select a preferred network,
the computer program product being configured to effect the connection of the wireless communications device to the preferred network.

26. (canceled)

27. A method of connecting a wireless communications device to a preferred network, the method comprising:
sending a piece of information from the wireless communications device via a plurality of networks to a target device;
deriving one or more operational characteristics of each of the plurality of networks;
comparing the one or more operational characteristics to thereby select a preferred network; and
connecting the wireless communications device to the preferred network.
